(19) United States
(12) Patent Application Publication
(10) Pub. No.: US 2004/0013386 A1
(43) Pub. Date: Jan. 22, 2004

(54) Optical device and method of manufacture thereof

(75) Inventor: Siddhartha Bhowmik, Allentown, PA (US)

Correspondence Address: HITT GAINES P.C., P.O. BOX 832570, RICHARDSON, TX, 75083, US

(73) Assignee: Agere Systems, Inc., Allentown, PA

(21) Appl. No.: 10/199,586

(22) Filed: Jul. 19, 2002

(51) Int. Cl. G02B 6/10

(52) U.S. Cl. 385/130

(57) ABSTRACT

The present invention is directed to an optical waveguide ridge having a waveguide formed therein and a method of manufacturing that optical waveguide ridge. The optical waveguide ridge has sidewalls that are more vertical than those previously manufactured. These increase in verticality is achieved by performing a plasma etch with an etchant on an optoelectronic substrate and adjusting a process parameter of the plasma etch to form a polymer layer over the optoelectronic substrate. In addition, the method includes readjusting the process parameter to etch the polymer layer and the optoelectronic substrate.

### TECHNICAL FIELD OF THE INVENTION

The present invention is directed, in general, to an optical device and its manufacture and, more specifically, to a ridge having waveguides formed therein and having more vertically oriented side walls and a method of manufacture thereof.

### BACKGROUND OF THE INVENTION

Optical devices have continued to gain popularity in today's semiconductor markets. Primarily because of their fast data transfer speeds and relatively precise manufacture, optoelectronic devices have become the components of choice for technology companies desiring high-speed information transmission capabilities. Accordingly, as the transfer of information becomes one of the most valuable commodities in the world, semiconductor manufacturers are eager to develop further improvements in optoelectronic technology.

Among optical devices, optical waveguides continue to gain widespread use. Optical waveguides are devices typically formed on optoelectronic substrates and are configured to optically propagate information from one point to another. As is well known, a waveguide may be formed by changing the refractive index of a section of the material selectively on the substrate, such that the material becomes transparent to the optical signal at that particular wavelength and under certain conditions. In a simple waveguide device, an electric field can be used to change the refractive index of the material back and forth to form a switching device. Several techniques can be used to increase the electrooptic efficiency, i.e., the voltage required for this switching. One common technique is to form ridges on top of the waveguides, which involves etching of the substrate around the waveguide. Though beneficial, conventional manufacturing processes employed to form these optical waveguides have proven troublesome, particularly with respect to ridge waveguides. Ridge waveguides are typically formed by first implanting a waveguide material, such as titanium, into an optoelectronics substrate, such as lithium niobate (LiNbO₂). Subsequent to this implantation, the optoelectronics substrate is etched to form a ridge structure from the substrate. The ridge structure has a designed height with substantially non-perpendicular sidewalls. The non-perpendicularity of the sidewalls is largely attributable to conventional manufacturing techniques that typically result in a ridge having sidewalls less than about 65° with respect to the underlying substrate.

One technique employed to form ridges from silicon wafer has been ion milling that involves bombarding a substrate with a focused ion beam in an effort to etch into the semiconductor material comprising the substrate. Unfortunately, however, the optoelectronic substrates mentioned above are very susceptible to wafer breakage due to high thermal stress that results from the intense temperatures and high energy involved in the ion milling process. These negative repercussions arise only when the substrate is etched to depths of around about 2 μm to 3 μm. As a result, applications employing ridges having heights of 4 μm or greater are typically beyond the abilities of the ion milling technique. In addition, ion milling typically is a process that leaves significant residues and a high loss of the masking material that makes the etch chamber dirty very quickly, which in turn, forcing equipment downtime.

Another technique often employed to manufacture optical devices is reactive ion etching (RIE). In the RIE process, etching chemicals and ion bombardment are simultaneously used on the substrate to form, for example, a ridge by etching away unwanted material. Unfortunately, RIE is also not without its problems. Perhaps the most critical challenge is the isotropic nature of the RIE etching process. Although ridges and similar structures may be successfully formed, the isotropic nature of the process leads to lateral attack of the material used to form the ridges. As a result, the sidewalls of the resulting ridge usually have a sidewall angle of no better than about 55°, with respect to the substrate. Due to the microscopic size of today's optical devices, with ridges typically on the order of about 10 μm to 15 μm wide and about 4 μm to 8 μm tall, a 55° sidewall angle leaves a smaller upper surface area on which to place an electrode.

Yet another disadvantage found in the ion milling and RIE processes is the polymer residue that usually forms inside the etching chamber. This residue comes from components typically included in the plasma etchant compound used during these manufacturing processes. In practice, the contamination caused by the polymer residue often requires technicians to thoroughly clean the plasma etch chamber after only a few wafers have been processed. Of course, during cleaning the downtime of the chamber can directly and significantly affect the manufacturing costs and time associated with constructing the optical devices.

Accordingly, what is needed in the art is a method of manufacturing an optical waveguide that does not suffer from the deficiencies found in the prior art.

### SUMMARY OF THE INVENTION

To address the above-discussed deficiencies of the prior art, the present invention provides a method of manufacturing an optical device. In one embodiment, the method includes subjecting an optoelectronic's substrate to a plasma that has an etch rate associated therewith, adjusting a process parameter of the plasma to form a polymer layer over the optoelectronic substrate, and etching the polymer layer and the optoelectronic substrate with the plasma.

In another embodiment, the present invention provides a method of manufacturing an optical device. In this particular embodiment, the method includes subjecting an optoelectronic substrate to a plasma that has an etch rate associated therewith, adjusting a process parameter of the plasma to form a polymer layer comprising an element of a component of the plasma over the optoelectronic substrate, etching the polymer layer and the optoelectronic substrate with the plasma, and repeating the adjusting and the etching.

In yet another aspect, the present invention provides an optical device that includes an optoelectronic substrate and a ridge having optical waveguides formed therein and having side walls having an angle with respect to said optoelectronic substrate greater than about 65° equal to or less than about 90°.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the present invention.

### BRIEF DESCRIPTION OF THE DRAWINGS

For a more complete understanding of the present invention, reference is now made to the following detailed description taken in conjunction with the accompanying FIGUREs. It is emphasized that various features may not be drawn to scale. In fact, the dimensions of various features may be arbitrarily increased or reduced for clarity of discussion. In addition, it is emphasized that some circuit components may not be illustrated for clarity of discussion. Reference is now made to the following descriptions taken in conjunction with the accompanying drawings, in which:

FIG. 1 illustrates an initial device early in one embodiment of a method of manufacturing according to the principles of the present invention;

FIG. 2 illustrates the initial device of FIG. 1 at a later time of manufacture;

FIG. 3 illustrates the initial device at a further time of manufacture;

FIG. 4 illustrates the initial device during a polymerization step of the method of manufacturing of the present invention;

FIG. 5 illustrates the initial device during a plasma etch step of the method of manufacturing of the present invention;

FIG. 6 illustrates the initial device during another polymerization step of the method of manufacturing of the present invention;

FIG. 7 illustrates the initial device during another plasma etch step of the method of manufacturing of the present invention;

FIG. 8 illustrates the initial device further during the second plasma etch step illustrated in FIG. 7;

FIG. 9 illustrates a completed semiconductor device manufactured according to the principles of the present invention described herein;

FIG. 10 illustrates an SEM image of a cross section of an optical waveguide manufactured using a conventional plasma process;

FIG. 11 illustrates an SEM image of a cross section of another embodiment of an optical waveguide manufactured according to the principles of the present invention; and

FIG. 12 illustrates an SEM image of a cross section of yet another embodiment of an optical waveguide manufactured according to the principles of the present invention.

### DETAILED DESCRIPTION

Referring initially to FIG. 1, illustrated is one embodiment of an optical device 100 early in the stage of manufacturing processes as covered by the present invention. As illustrated, the optical device 100 is formed over an optoelectronic substrate 110. The optoelectronic substrate 110 does not include silicon but does include electro-optic materials, such as, lithium niobate (LiNbO₃), lithium tantalate (LiTaO₃), barium titanium oxide (BaTiO₃), quartz and other similar materials. Alternatively, the optoelectronic substrate 110 may include compound semiconductor materials, such as, indium phosphide (InP), gallium arsenide (GaAs), aluminum gallium arsenide (AlGaAs), gallium nitride (GaN), indium gallium arsenide (InGaAs), lead sulfide (PbS), cadmium tellurium (CdTe) and other similar materials. Also shown are waveguides 115 that have been conventionally formed in the optoelectronic substrate 110. The waveguides 115 may be any material, such as titanium, that is typically used to form waveguides within such substrates.

Located over the optoelectronic substrate 110 is an optional adhesive layer 120. In those embodiments where the adhesive layer 120 is present, a mask layer 130 is deposited over it. Alternatively, when the adhesive layer 120 is not present, the mask layer 130 is simply deposited over the optoelectronic substrate 110. In an advantageous embodiment, the mask layer 130 is a photoresist material and the adhesive layer 120 is deposited as part of the photoresist formation process to assist adherence of the mask layer 130 to the optoelectronic substrate 110. In an alternative embodiment, the mask layer 130 can be a hard mask, perhaps formed with nickel (Ni) or titanium (Ti). In embodiments where a hard mask is used, the adhesive layer 120 may also include Ni to allow better adherence of the mask layer 130 to the optoelectronic substrate 110. It should be understood, however, that an optical device constructed according to the present invention is not limited to any particular materials for the adhesive and mask layers 120, 130.

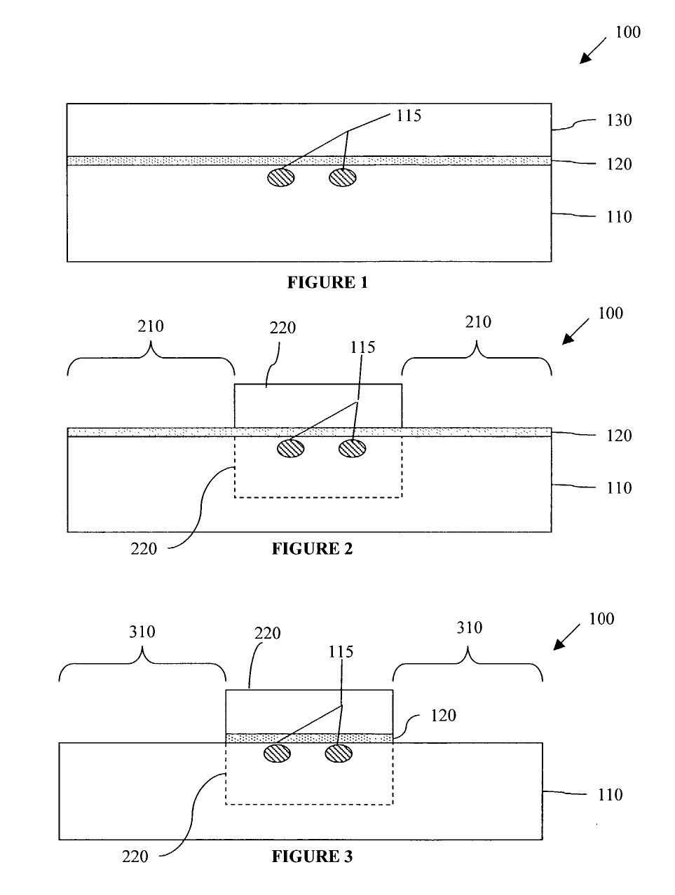

Turning to FIG. 2, illustrated is the initial device 100 of FIG. 1 after the mask layer 130 has been conventionally patterned and a portion thereof removed. As illustrated, once unwanted areas of the mask layer 130 are removed, exposed portions 210 of the adhesive layer 120 are created. After the removal process, a portion 220 of the mask layer 130 remains on the optoelectronic substrate 110.

Looking now at FIG. 3, illustrated is the initial device 100 of FIG. 2 after removing the exposed portions 210 of the adhesive layer 120. Once removed, portions 310 of the optoelectronic substrate 110 are exposed. The exposed portions 210 of the adhesive layer 120 may be removed by any of several conventional processes, including, but not limited to, wet etching, dry etching or other known removal processes.

At this point in manufacture, the optoelectronic substrate 110 is positioned within a plasma chamber to complete the etching process. The plasma chamber, which is not shown, is of conventional design, and as such, includes a coil and a platen across which an electrical bias is formed to create a plasma that can be adjusted to have a net etching or deposition affect.

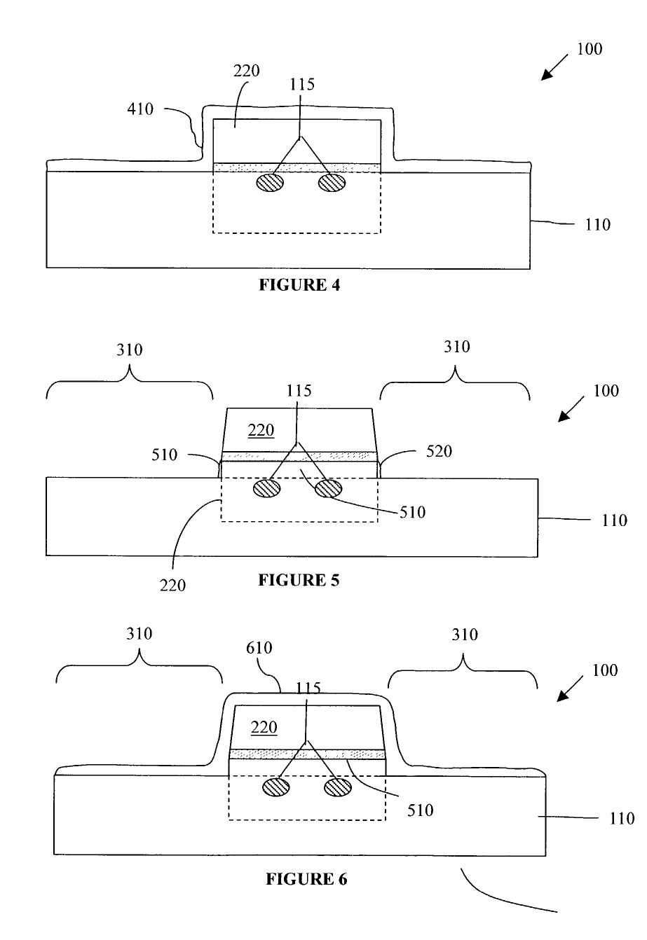

Referring now to FIG. 4, illustrated is the initial device 100 showing deposition of a polymer layer. In accordance with the principles disclosed herein, a process parameter of the plasma is adjusted to form polymer layer 410 over the exposed portions 310 of the optoelectronic substrate 110, as well as the remaining mask layer 130 to yield a net deposition process as explained below. The polymer layer 410 is formed from an element contained in the plasma etch. In an advantageous embodiment, the polymer layer 410 is formed prior to conducting any etch on the optoelectronic substrate 110. However, in other embodiments, the polymer layer 410 may be formed during the etching process.

In an exemplary embodiment, the plasma contains an etching component, such as carbon tetrachloride (CF₄) or sulfur hexafluouride (SF₆), and a polymerizing component. In advantageous embodiments, the polymerizing component contains a carbon moiety, such as a hyrdofluorocarbon or a fluorocarbon. Examples of such hyrdofluorocarbons include methyl trifluoride (CHF₃), butyl-octafluoride (C₄F₈) or ethyl-hexafluroide (C₂F₈) Hydrogen may or may not be present to increase polymer formation. A process parameter of the plasma may be adjusted by introducing the polymerizing component into the plasma at the time the formation of polymer layer 410 is desired, or the flow of the polymerization component may be simply increased if it is already present in the plasma. The introduction or increase of the polymerizing component into the plasma can cause the etching rate of the plasma to decrease. In such instances, the power to the coil and platen are increased to restore the etching rate after the polymer layer 410 is formed. After the formation of the polymer layer 410, the plasma is then operated to etch away part of the exposed portions 310 of the optoelectronic substrate 110. In an advantageous embodiment, the plasma also includes argon (Ar) ions, however other appropriate ions may also be employed.

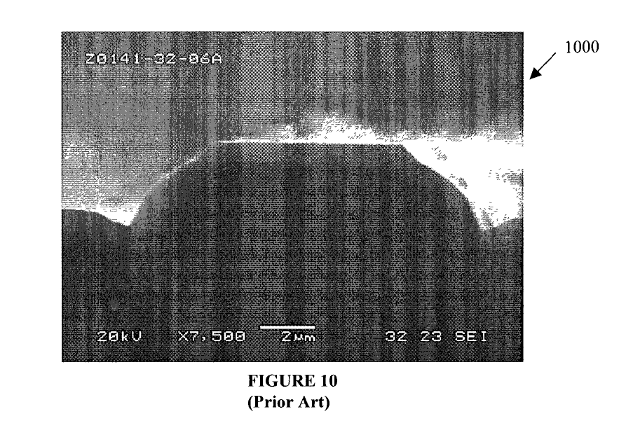

Turning to FIG. 5, illustrated is the initial device 100 during a plasma etch step according to a method of manufacture as covered by the present invention. After formation of polymer layer 410, etching is continued to remove the newly formed polymer layer 410, as well as the exposed portions 310 of the optoelectronic substrate 110. Thus, a small device portion 510 is formed from the protected portion 220 of the optoelectronic substrate 110. As the exposed portions 310 of the optoelectronic substrate 110 are etched away to form the desired structure, most, if not all, of the polymer layer 410 is etched away. However, small sidewall portions 520 are typically left during a part of the plasma etch process. In RIE conventional processes, once etching of the optoelectronic substrate is underway, sidewalls are partially protected by re-deposition of material from the etch process. As discussed above, however, the predominantly downward etch of conventional plasma etch processes still tends to laterally attack the sidewalls of the initial device 100. Such a sidewall attack may be seen in the tapered sides of the mask layer 130 formed during the plasma etch. As seen from x-sectional profiles this lateral attack (see FIG. 10 prior art) is more in the initial stages of RIE process. In the present invention by forming the polymer layer 410 over the mask layer 130 and the optoelectronic substrate 110 and the mask layer 130, the tendency to horizontally attack the sidewalls of the different layers in the initial device 100 is significantly reduced. The polymeric sidewall is protected from the etchant species and radicals with its relative inertness to the chemistries employed.

Looking now at FIG. 6, illustrated is the initial device 100 during another polymerization step according to a method of manufacturing of the present invention. Beneficially, the polymerization step completed above may be repeated to form a second polymer layer 610 once the small sidewall portions 510 have been etched away. The second polymer layer 610 may be formed using the same process discussed above. Specifically, a process parameter, such as the electrical bias across the optoelectronic substrate 110, may be adjusted so that etching of the exposed portions 310 of the optoelectronic substrate 110 subsides and the second polymer layer 610 begins to form. Also, as before, the thickness of the second polymer layer 610 may be the same as the thickness of the first polymer layer 410.

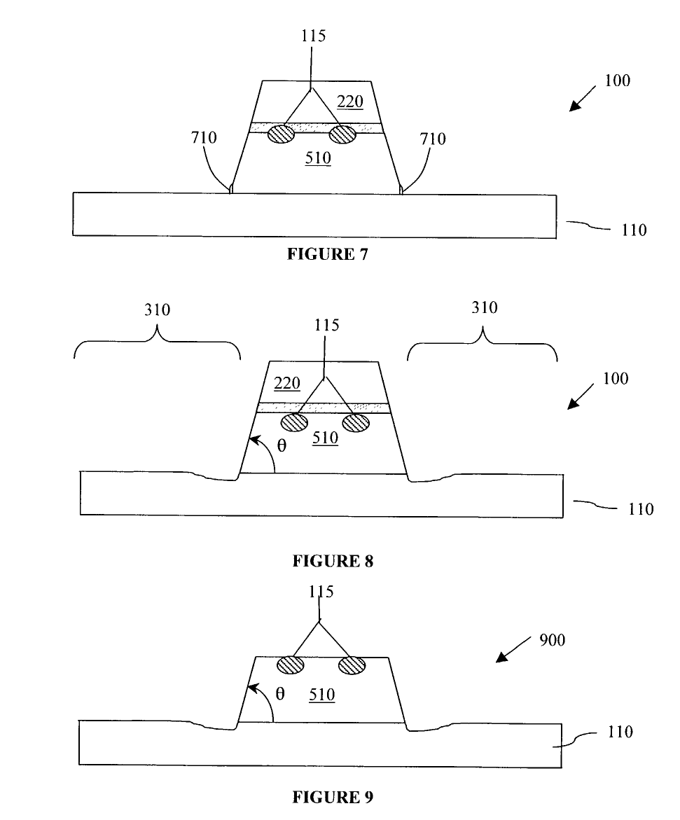

Referring now to FIG. 7, illustrated is the initial device 100 during another plasma etch step according to a method of manufacturing of the present invention. As with the first plasma etch step discussed above, during the second plasma etch step the parameter adjusted above to allow formation of the second polymer layer 610 is again readjusted to begin etching the second polymer layer 610. In addition, the plasma etchant continues to downwardly etch the exposed portions 310 of the optoelectronic substrate 110 as well. As the exposed portions 310 of the optoelectronic substrate 110 are further etched, most of the second polymer layer 610 is also etched away therewith. However, as with the first polymer layer 410, small sidewall portions 710 are typically left since the chemicals and bias used for plasma etching primarily etch in a downward direction. As may be seen from the tapered sidewalls along both the mask layer 130 and the device portion 520, the second polymer layer 610 does not prevent all horizontal attack levied by the plasma etchant. However, as noted above, significant reduction in the horizontal attack may be achieved with use of the polymer layers 410, 610, in accordance with the principles of the present invention.

Turning now to FIG. 8, illustrated is the initial device 100 further during the second plasma etch step illustrated in FIG. 7. As shown, the second plasma etching step is completed as per requirements of device requirements. The above steps may be repeated several times to achieve dimensions as required.

Looking now at FIG. 9, illustrated is a completed optical device 900 manufactured according to the principles of the present invention described herein. As shown, the plasma etch occurring earlier has been completed. In addition, the remaining mask layer 130 and remaining adhesive layer 120 are also removed. Those skilled in the art understand the numerous methods employed to remove these layers, so that discussion will not be presented here.

As illustrated by the completed optical device 900 of FIG. 9, the use of one or more polymer layers has resulted in a significant reduction of the horizontal attack of the plasma etchant. This significant reduction allows for a sidewall angle (θ) substantially closer to 90 degrees, as compared to the techniques employed in the prior art. Moreover, the beneficial sidewall angle may be achieved without jeopardizing the physical integrity of the underlying substrate. As a comparison, where prior art techniques typically result in sidewall angles in the range of about θ=55°-65°, the method of the present invention may achieve sidewall angles in the range of about θ=70°-80°, and perhaps as high as 90°. In addition, as mentioned above, the process of forming a polymer layer, followed by partially etching the underlying substrate, may be repeated multiple times to achieve sidewall angles closer to 90 degrees than achievable with prior art methods. Moreover, the more carefully the adjustments and readjustments to the selected process parameters are made, the more horizontal attack by the plasma etchant is curtailed. As a result, the likelihood of forming sidewall angles closer to 90° increases.

### Experimental Results

For exemplary purposes only, experimental results associated with the method of the present invention employed to manufacture an optical waveguide follows. The following experimental results illustrate advantages associated with the method of the present invention and are not intended to limit the broad scope of the present invention.

Returning to FIG. 10 shown is a sectional view, taken with a scanning electron microscope (SEM) , of a ridge structure etched with a conventional plasma process flow of CHF₃ at 95 sccm and a flow of argon at 5 sccm. The angle seen is between 42-45 degrees at calculated etch rate of about 45 nm/minute, which is well below the angles provided by the method of the present invention. Even when the flows were reversed (e.g., argon at 95 sccm and CHF₃ at 5 sccm) the sidewall angles of the ridge structure only improved to 55-62 degrees, at etch rates of about 54 nm/minute.

Several sets of experiments were carried out with an aim to increase the verticality of the ridge structure's sidewalls, in accordance with the principles of the present invention. In one of the experiments, a sequence was created with alternate steps of etching and polymerization. This particular sequence was carried out with several steps of a CF₄ and argon mix in the first step followed by alternating steps of C₄F₈ plasma to form a polymerizing layer. An improvement in the sidewall angle was noted to be between 62-64 degrees and achieved at an etch rate of about 56 nm/minute.

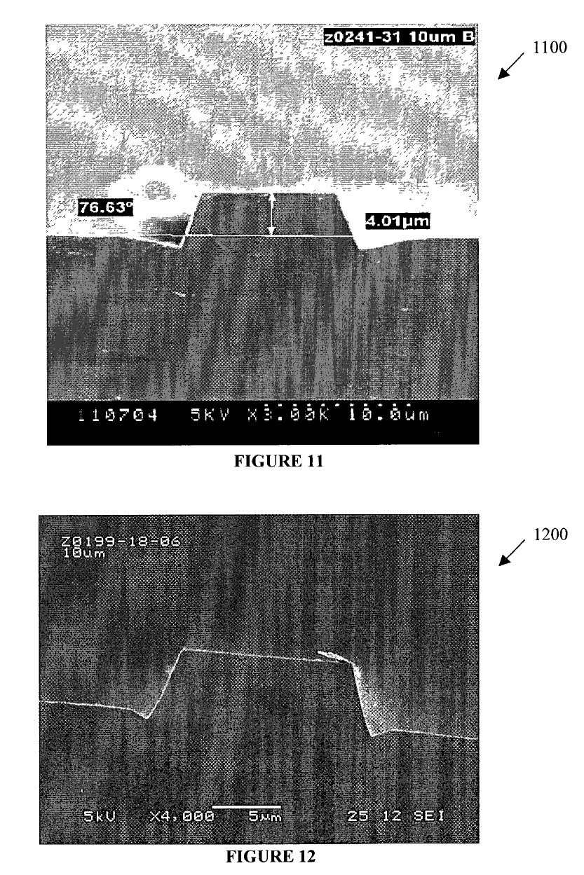

A slight modification was done on the recipe with alternate steps of etching and polymerization, by introducing the polymerization step in the beginning of the process sequence, prior to the first etch step. It is believed that the tapering at the top of the ridge happens at the beginning stages of etching where the sidewall is etched as no polymer or residue formed and no protection was available. The sidewall angle also increased to more than 75 degrees, as shown in FIG. 11.

A processing sequence was also carried out on wafers having a nickel mask using a similar sequence of polymerization and etching. The resultant x-sectional profile si shown in FIG. 12.

By providing a method of manufacturing an optical device employing a polymerization step during a plasma etch of the device structure, the present invention provides several benefits over the prior art. For instance, the present invention provides a process that results in steeper device sidewalls than typically achieved with prior art techniques. Those skilled in the art understand that sidewall angles closer to 90° allow for more confinement of the electrical field present in optical devices, such as optical waveguide modulators. In this example, a more efficient waveguide modulator may be formed for transferring optical signals. Moreover, the polymerization step provided by a manufacturing process according to the present invention is employable in almost any process where plasma etching is employed to form optical or semiconductor devices, while retaining benefits such as those described above.

Additional advantages of the process of the present invention includes the capability of employing a thinner mask layer 130 than is typically used during device formation. Since the vertical etching of the plasma etchant is also somewhat curtailed, along with the sidewall etching, by the multiple polymer layers, less of the mask layer is lost throughout the device formation process. In today's competitive markets, most optical manufacturers would be understandably eager to lessen the material costs associated with patterning and etching various optical devices, as well as the time needed to lay down thicker mask layers. Another significant advantage achieved with the present invention is the reduction or elimination of process downtime associated with cleaning the chambers in which the etching processes are conducted. As discussed above, typical plasma etch processes generate polymer residue during etching of the substrate, and that residue tends to accumulate on the inside walls of the etching chamber. By adjusting selected process parameters during the plasma etch, the polymer residue predominately accumulates on the substrate, as desired by the process of the present invention. Since the residue accumulates on the substrate rather than the inside of the chamber, less down time associated with cleaning the polymer residue from within the chamber is required. The cost savings associated with less process downtime, as well as the redirection of manpower toward other endeavors, should also be a welcome sight to semiconductor manufacturers.

Although the present invention has been described in detail, those skilled in the art should understand that they can make various changes, substitutions and alterations herein without departing from the spirit and scope of the invention in its broadest form.

What is claimed is:

1. A method of manufacturing an optical device, comprising:
subjecting an optoelectronic substrate having a waveguide formed therein to a plasma, said plasma having an etch rate associated therewith;
adjusting a process parameter of said plasma to form a polymer layer over said optoelectronic substrate; and
etching said polymer layer and said optoelectronic substrate with said plasma.

2. The method as recited in claim 1 wherein said plasma includes an etch gaseous component and a polymerizing component and said etch gas component includes CF₄, SF₆, CHF₃ or Cl and said polymerizing component includes C₄F₈ or C₂F₆.

3. The method as recited in claim 2 wherein said adjusting includes introducing a polymerizing compound and forming said polymer layer prior to etching said optoelectronic substrate.

4. The method as recited in claim 1, wherein adjusting includes increasing an electrical bias across said plasma wherein said increasing includes increasing a power on a coil by about 100 to about 200 watts and increasing a power on a platen by about 100 to about 300 watts.

5. The method as recited in claim 1 wherein said adjusting and etching forms an optical waveguide ridge from said optoelectronic substrate, wherein said optoelectronic substrate comprise electro-optic materials or compound semiconductor materials.

6. The method as recited in claim 5 wherein said adjusting and etching cause side walls of said optical waveguide ridge to have an angle with respect to said optoelectronic substrate greater than about 65° and equal to or less than about 90°.

7. The method as recited in claim 1 wherein said plasma includes a carbon moiety and said polymer layer is a polymer of said carbon moiety.

8. The method as recited in claim 1 further including repeating said adjusting and said etching.

9. The method as recited in claim 1 further including forming another device optically coupled to the optical device, thereby forming an optical communications system.

10. A method of manufacturing an optical device, comprising:
subjecting an optoelectronic substrate to a plasma, said plasma having an etch rate associated therewith;
adjusting a process parameter of said plasma to form a polymer layer;
etching said polymer layer and said optoelectronic substrate with said plasma; and
repeating said adjusting and said etching.

11. The method as recited in claim 10 wherein said adjusting decreases said etch rate.

12. The method as recited in claim 11 wherein said adjusting includes introducing a polymerizing compound and forming said polymer layer prior to etching.

13. The method as recited in claim 10, wherein adjusting includes increasing an electrical bias across said plasma and said increasing includes increasing a power on a coil by about 100 to about 200 watts and increasing a power on a platen by about 100 to about 300 watts.

14. The method as recited in claim 10 wherein said adjusting and said etching creates an optical waveguide ridge with side walls that have an angle with respect to said optoelectronic substrate greater than about 65° and equal to or less than about 90°.

15. The method as recited in claim 10 wherein said plasma includes an etch gaseous component and a polymerizing component.

16. The method as recited in claim 15 wherein said etch gas component includes CF₄, SF₆, CHF₃ or Cl and said polymerizing component includes C₄F₈ or C₂F₆.

17. An optical device, comprising:
an optoelectronic substrate having a waveguide formed therein; and
an optical waveguide ridge having side walls having an angle with respect to said optoelectronic substrate greater than about 65° and equal to or less than about 90°.

18. The optical device as recited in claim 17 wherein said optical waveguide ridge is formed from said optoelectronic substrate.

19. The optical device as recited in claim 17 wherein said optical waveguide ridge is formed from a lithium niobate substrate.

20. The optical device as recited in claim 17 wherein the optical device comprises a portion of an optical communications system.
